(19) United States
(12) Patent Application Publication
(10) Pub. No.: US 2013/0304555 A1
(43) Pub. Date: Nov. 14, 2013

(54) METHOD AND SYSTEM FOR APPLYING COUPON RULES TO A FINANCIAL TRANSACTION

(71) Applicant: Peter GROARKE, Dublin (IE)

(72) Inventor: Peter GROARKE, Dublin (IE)

(73) Assignee: MasterCard International Incorporated, Purchase, NY (US)

(21) Appl. No.: 13/470,664

(22) Filed: May 14, 2012

(51) Int. Cl. G06Q 30/02

(52) U.S. Cl. 705/14.23

(57) ABSTRACT

A method for applying coupon rules to a financial transaction includes storing a plurality of coupon rules, each coupon rule associated with a consumer and a merchant and including an amount modifier and funding account number; receiving an authorization request for a financial transaction, the authorization request including a consumer identifier, a merchant identifier, and a transaction amount; identifying, at least one coupon rule of the plurality of coupon rules where the associated consumer corresponds to the consumer identifier and the associated merchant corresponds to the merchant identifier; modifying the financial transaction based on the at least one coupon rule by modifying the transaction amount based on the amount modifier; and transmitting a reply to the authorization request, the reply to the authorization request including at least the modified transaction amount.

### FIELD

The present disclosure relates to applying coupon rules to a financial transaction, specifically automatically applying coupon rules to a transaction when an associated payment card is used to fund the transaction.

### BACKGROUND

For well over a century, consumers have used coupons to save on consumer products and services. In more recent times, loyalty programs and other reward platforms have also entered mainstream use, offering alternative, or sometimes additional, incentives and discounts to consumers. Most recently, the combination of the Internet, mobile computing, and social network has seen the rise of purchasable coupon deals where consumers can buy discounts and share offers with their social circles.

However, as the available opportunities for consumers to save increases, the number of coupons, loyalty cards, and reward programs that consumers must keep track of to maximize value and enjoyment of couponing also increases. A consumer may have a loyalty card for businesses in any number of industries, such as for groceries, restaurants, retail stores, airlines, etc. In many instances, a consumer might have a loyalty card for multiple businesses in a single industry, such as a consumer having a loyalty card for several local grocery stores and/or department stores. This results in the consumer often needing to carry and keep track of a multitude of cards, which requires significant organization and can be inconvenient, particularly if expected to carry physical reward cards or loyalty cards.

Consumers that use coupons often find themselves in the same situation. A consumer may have any number of manufacturer-specific, merchant-specific coupons, and/or product-specific coupons, each with varying expiration dates. Keeping the coupons organized can become a daunting task for many consumers, and can often discourage a consumer from their use. Thus, there is a perceived opportunity to improve the technology in delivery, storing, tracking and use of coupons and loyalty programs in commerce, specifically to allow for merchants and consumers alike to continue to use these services but without the difficulties of existing systems.

### SUMMARY

The present disclosure provides a description of systems and methods for applying coupon rules to a financial transaction that depending on implementation, can provide technical solutions to one or more of the pre-existing problems with coupon, loyalty and/or rewards programs.

A method for applying coupon rules to a financial transaction includes storing, in a database, a plurality of coupon rules, wherein each coupon rule of the plurality of coupon rules is associated with a consumer and a merchant and includes at least an amount modifier and a funding account number, and receiving, by a receiving device, an authorization request for a financial transaction, wherein the authorization request includes at least a consumer identifier, a merchant identifier, and a transaction amount. The method further includes identifying, in the database, at least one coupon rule of the plurality of coupon rules where the associated consumer corresponds to the consumer identifier and the associated merchant corresponds to the merchant identifier, and modifying the financial transaction based on the at least one coupon rule wherein modifying the financial transaction includes at least modifying the transaction amount based on the amount modifier. The method also includes transmitting, by a transmitting device, a reply to the authorization request, and the reply to the authorization request including at least the modified transaction amount.

Another method for applying coupon rules to a financial transaction includes storing, in a database, a plurality of coupon rules, wherein each coupon rule of the plurality of coupon rules is associated with a consumer and a merchant and includes at least an amount modifier and a funding account number, and receiving, by a receiving device, an authorization request for a financial transaction, wherein the authorization request includes at least a consumer identifier, a merchant identifier, and a transaction amount. The method further includes identifying, in the database, at least one coupon rule of the plurality of coupon rules where the associated consumer corresponds to the consumer identifier and the associated merchant corresponds to the merchant identifier, and transmitting, by a transmitting device, a reply to the authorization request, the reply to the authorization request including at least the modified transaction amount. The method also includes issuing a credit to an account associated with the associated consumer based on the at least one coupon rule wherein the credit is for a credit amount based at least on the amount modifier.

A system for applying coupon rules to a financial transaction includes: a database, a receiving device, a processor, and a transmitting device. The database is configured to store a plurality of coupon rules, wherein each coupon rule of the plurality of coupon rules is associated with a consumer and a merchant and includes at least an amount modifier and a funding account number. The receiving device is configured to receive an authorization request for a financial transaction, the authorization request including at least a consumer identifier, a merchant identifier, and a transaction amount. The processor is configured to: identify, in the database, at least one coupon rule of the plurality of coupon rules where the associated consumer corresponds to the consumer identifier and the associated merchant corresponds to the merchant identifier; and modify the financial transaction based on the at least one coupon rule wherein modifying the financial transaction includes at least modifying the transaction amount based on the amount modifier. The transmitting device is configured to transmit a reply to the authorization request, the reply to the authorization request including at least the modified transaction amount.

Another system for applying coupon rules to a financial transaction includes: a database, a receiving device, a processor, and a transmitting device. The database is configured to store a plurality of coupon rules, wherein each coupon rule of the plurality of coupon rules is associated with a consumer and a merchant and includes at least an amount modifier and a funding account number. The receiving device is configured to receive an authorization request for a financial transaction, the authorization request including at least a consumer identifier, a merchant identifier, and a transaction amount. The processor is configured to: identify, in the database, at least one coupon rule of the plurality of coupon rules where the associated consumer corresponds to the consumer identifier and the associated merchant corresponds to the merchant identifier; and issue a credit to an account associated with the associated consumer based on the at least one coupon rule wherein the credit is for a credit amount based on at least the amount modifier. The transmitting device is configured to transmit a reply to the authorization request, the reply to the authorization request including at least the modified transaction amount.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a financial transaction processing system in accordance with exemplary embodiments.

FIG. 2 is a block diagram illustrating a system for applying coupon rules to a financial transaction in accordance with exemplary embodiments.

FIG. 3 is a block diagram illustrating a financial transaction processing server in accordance with exemplary embodiments.

FIG. 4 is a block diagram illustrating a coupon rule data set in accordance with exemplary embodiments.

FIGS. 5A and 5B are a flow diagram illustrating a method of applying coupon rules to a financial transaction by modifying the financial transaction, in accordance with exemplary embodiments.

FIGS. 6A and 6B are a flow diagram illustrating a method of applying coupon rules to a financial transaction by issuing a credit in accordance with exemplary embodiments.

FIG. 7 is a block diagram illustrating an exemplary computer system for use in the systems of FIGS. 1 and 2 in accordance with exemplary embodiments.

FIGS. 8 and 9 are flow charts illustrating exemplary methods for applying coupon rules to a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Financial Transaction—An event that involves the exchange of money or payment between two parties. For example, a consumer purchasing goods or services from a merchant, a borrower borrowing money from a lender, a consumer giving a bank money for deposit in a bank account, etc. As described herein, a payment card transaction may include a financial transaction where a payment card is used for payment.

Payment Card—A card associated with a payment account that can be used for payment in a financial transaction (e.g., a payment card transaction). The term “payment card” may encompass any physical or virtual payment card or payment card number (e.g., an account number, virtual card number, virtual payment number, etc.) associated with a payment account that may be used. Traditional payment card types may include a credit card, charge card, debit card, stored-value card, fleet card, etc.

Issuer—An entity that issues a payment card to a consumer. Types of entities that may be an issuer may include a financial institution, such as a bank or credit union, a financial transaction processing agency, a merchant, or any other organization or institution that may issue a payment card to a consumer.

Acquirer—An entity that acts as an intermediary between merchants and consumers. For example, an acquirer may process financial transactions on behalf of the merchant, such as by communicating with the consumer's issuer to secure funds for a payment card transaction. Types of entities that may be an acquirer include entities discussed above that may act as an issuer, such as a bank, but can be other types of entities as well.

Financial Transaction Processing Agency—An entity that processes financial transaction (e.g., payment card transactions), such as MasterCard, VISA, American Express, etc. In many instances, a financial transaction processing agency may act on behalf of, or may operate as, an acquirer and/or an issuer. For example, a financial transaction processing agency may issue a payment card to a consumer, and then process a transaction using that payment card by paying the transaction amount to a merchant and billing the consumer for the amount.

### Financial Transaction Processing System

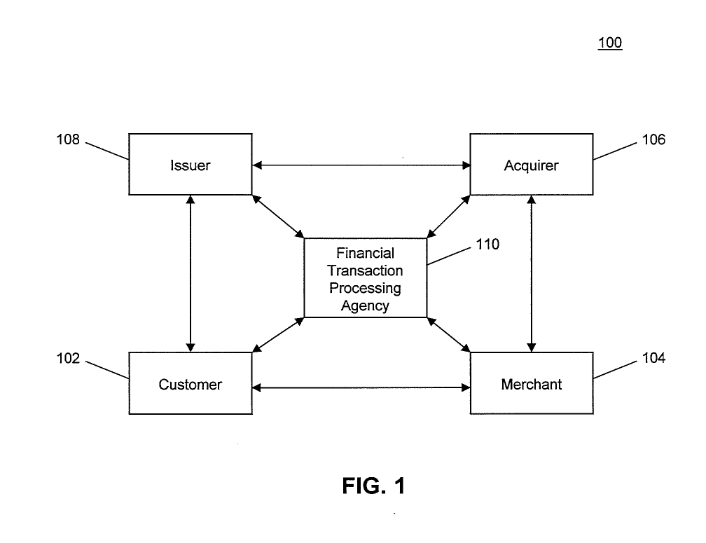

FIG. 1 illustrates a system 100 for processing a financial payment card transaction. The system 100 may include a costumer 102 that may initiate or otherwise engage in a financial transaction with a merchant 104. The customer 102 may be at a physical location of the merchant 104, such as in a storefront, or may be conducting the transaction with the merchant 104 remotely, such as through a website of the merchant 104.

The customer 102 may have a payment card issued by an issuer 108, which may be used to pay for the financial transaction. The merchant 104 may provide details of the financial transaction to an acquirer 106. Transaction details may include costumer information, merchant information, transaction amount, date and time information, product or service details, etc. In an exemplary embodiment, the transaction details include at least a consumer identifier associated with the customer 102 and a merchant identifier associated with the merchant 104.

The acquirer 106 may request authorization of the financial transaction from a financial transaction processing agency 110. In one embodiment, the acquirer 106 and the financial transaction processing agency 110 may be a single entity and the merchant 104 may request the authorization. The financial transaction processing agency 110 may apply coupon rules to the financial transaction, as will be discussed in more detail below. Alternatively or additionally, a separate entity, not illustrated, can provide the coupon rules, as also explained below. After application of the coupon rules, the financial transaction processing agency 110 may process the transaction, such as by contacting the issuer 108 for approval or denial of the transaction and reporting the same to the acquirer 106 or the merchant 104.

Once the transaction has been approved or denied, the merchant 104 can finalize the transaction with the customer 102. For example, if the transaction has been approved, the merchant 104 can provide the transacted—for goods or services to the customer 102 and receive payment (e.g., from the issuer 108), and the customer 102 can be billed for the transaction by the issuer 108.

### Application of Coupon Rules to a Financial Transaction

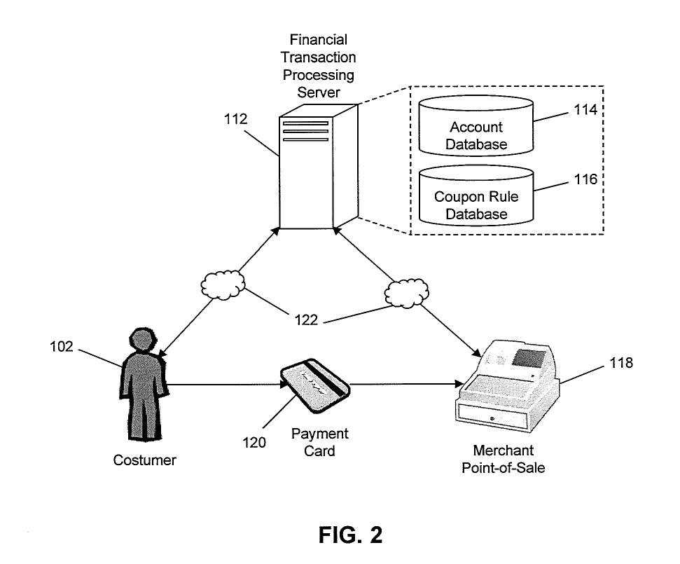

FIG. 2 illustrates a system for the application of coupon rules to a financial transaction, such as a financial transaction processing using the system 100 of FIG. 1.

The customer 102 may register (e.g., sign up and establish account details such as a password, completing a questionnaire about security questions, interests and demographics, as well as other types of activity) with the financial transaction processing agency 110 (FIG. 1), such as registering via a financial transaction processing server 112, which may be part of the financial transaction processing agency 110. Communication between the customer 102 and the financial transaction processing sever 112 may be via a network 122. The network 122 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Further, the network 122 may be coupled to, piggy-backed on or actually, in whole or in part, a financial transaction network, such as MasterCard's BankNet with the potential advantages of the pre-established security, connectivity, and acceptance. Other suitable network types and configurations will be apparent to persons having skill in the relevant art.

The financial transaction processing server 112 may store information related to the customer 102 in an account database 114, discussed in more detail below. In an exemplary embodiment, the financial transaction processing server 112 may store a payment card number corresponding to a payment card 120 (e.g., associated with the customer 102). The financial transaction processing server 112 may also include a coupon rule database 116, also discussed in more detail below.

The customer 102 may engage in a financial transaction with the merchant 104 and use the payment card 120 for payment for the transaction. The merchant 104 may begin processing the financial transaction using a merchant point-of-sale (POS) 118 (e.g., by reading the payment card 120 for a physical transaction or capturing provided details associated with the payment card 120 for a transaction conducted through a network). The merchant 104 may (e.g., via the merchant POS 118) transmit transaction details to the financial processing server 112. In some embodiments, the transaction details may be transmitted via the acquirer 106. Information included in the transaction details will be apparent to persons having skill in the relevant art, and may include merchant information, consumer information, payment card information, transaction amount, etc. In one embodiment, the transaction details may be transmitted in an authorization request. In a further embodiment, the authorization request may be formatted under the International Organization for Standardization ISO 8583 standard.

In an exemplary embodiment, the transaction details may include at least a consumer identifier (e.g., payment card number associated with the payment card 120), a merchant identifier (e.g., a unique number associated with the merchant 104), and a transaction amount. The financial transaction processing server 112 may identify an account associated with the payment card 120 and stored in an account database 114, such as by using the included consumer identifier. The financial transaction processing server 112 may use information stored in the account database 114 for processing the financial transaction. Information included in the account database 114 will be apparent to persons having skill in the relevant art and may include credit limits, account balances, etc.

The financial transaction processing server 112 may also identify at least one coupon rule in a coupon rule database 116, as discussed in more detail below. The financial transaction processing server 112 may apply the at least one coupon rule to the financial transaction to be processed. The financial transaction processing server 112 may then process the financial transaction, as described above. In some embodiments, the financial transaction processing server 112 may notify the customer 102 of any or all coupon rules applied to the financial transaction (e.g., by email, short message service (SMS) message, phone call, or other methods which may be previously selected by the customer 102).

### Financial Transaction Processing Server

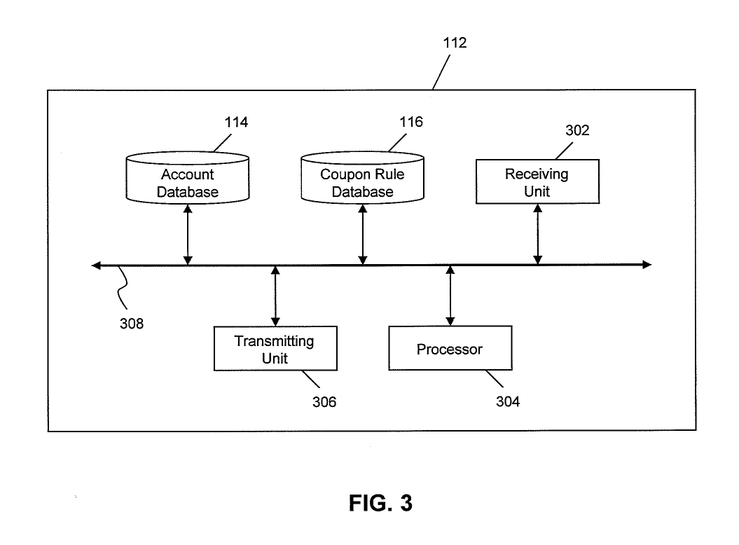

FIG. 3 is an illustration of an embodiment of the financial transaction processing server 112. The financial transaction processing server 112 may include the account database 114, the coupon rule database 116, a receiving unit 302, a transmitting unit 306, and a processor 304. The coupon rules database 116 may be part of the financial transaction processing agency, or a separate entity that receives at least part of transaction information so that it can act to modify the transaction accordingly, and report it to the appropriate parties (e.g., advertisement agencies, merchant or third parties). Each of the components may be connected via a bus 308. Types and configurations of the bus will be apparent to persons having skill in the relevant art.

The account database 112 and the coupon rule database 116 may include data stored on any type of suitable computer readable media, such as optical storage (e.g., a compact disc, digital versatile disc, blu-ray disc, etc.) or magnetic tape storage (e.g., a hard disk drive). The account database 112 and the coupon rule database 116 may be configured in any type of suitable database configuration, such as a relational database, a structured query language (SQL) database, a distributed database, an object database, etc. Suitable configurations and database storage types will be apparent to persons having skill in the relevant art. Each of the product database 112 and the coupon rule database 116 may be a single database, or may comprise multiple databases which may be interfaced together (e.g., physically or via a network, such as the network 122). In one embodiment, the account database 112 and the coupon rule database 116 may be a single database.

The account database 112 may include information on a plurality of payment card accounts. Suitable types of information included in payment card accounts will be apparent to persons having skill in the art. In an exemplary embodiment, each account in the plurality of payment card accounts may include at least a consumer identifier (e.g., a unique identifier associated with the customer 102). In one embodiment, the consumer identifier may be a payment card number corresponding to a payment card (e.g., the payment card 120) associated with the customer 102. The coupon rule database 116 may include a plurality of coupon rule data sets, discussed in more detail below. Each coupon rule in the coupon rule database 116 may be associated with at least a consumer (e.g., the customer 102), a merchant (e.g., the merchant 104), an amount modifier, and a funding account number, discussed further below.

The receiving unit 302 may be configured to receive transaction information (e.g., from the merchant 104 or the acquirer 106). In one embodiment, the receiving unit 302 may be configured to receive authorization requests formatted in the ISO 8583 standard. The receiving unit 302 may also be configured to receive information from the customer 102 (e.g., via the network 122), such as authenticating information, funding information, billing information, shipping information, and other types of information as will be apparent to persons having skill in the relevant art.

The processor 304 may be configured to process financial transactions and apply coupon rules to the financial transactions. Methods for applying a coupon rule to a financial transaction will be discussed in more detail below. The processor 304 may be a single processor or may be comprised of multiple processors. The processor 304 may also be comprised of one or more processor “cores.” The processor 304 may also be configured to identify information and/or data stored in the account database 114 and the coupon rule database 116.

The transmitting unit 306 may be configured to transmit a reply to an authorization request (e.g., to the merchant 104 or the acquirer 306). In one embodiment, the transmitting unit may be configured to transmit a reply formatted in the ISO 8583 standard. The transmitting unit 306 may also be configured to transmit information to the customer 102, such as information related to coupon rules associated with the customer 102, as discussed in more detail below.

### Coupon Rules

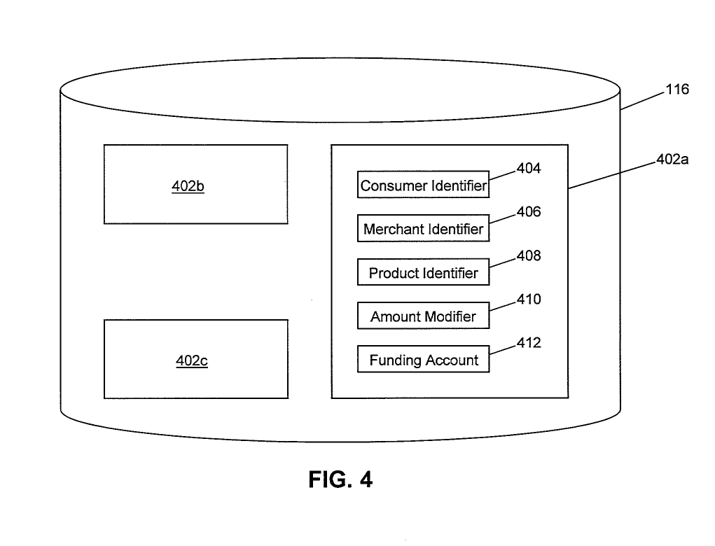

FIG. 4 illustrates the coupon rule database 116. The coupon rule database 116 may include a plurality of coupon rules 402. Each of the coupon rules 402 may include at least a consumer identifier 404, at least one merchant identifier 406, an amount modifier 410, and a funding account 412. In some embodiments, each coupon rule 402 may also include at least one product identifier 408. In one embodiment, each coupon rule 402 may also have a unique coupon identifier associated with the coupon rule 402.

The consumer identifier 404 may be a unique identifier associated with a consumer (e.g., the customer 102). Types of identifiers suitable for use as the customer identifier 404 will be apparent to persons having skill in the relevant art, such as a financial account number, a payment card number, or other unique number associated with the customer 102. The merchant identifier 406 may be a unique identifier associated with a merchant (e.g., the merchant 406). For example, the merchant identifier 406 may be a financial account number, a merchant identification number, or other suitable type of identifier as will be apparent to persons having skill in the relevant art.

The amount modifier 410 may be an amount to be applied to a financial transaction to modify the transaction amount. In some embodiments, the amount modifier 410 may be a number, such as representing a flat or percentage-based discount for a financial transaction. For example, the coupon rule 402 may include an amount modifier 410 of 5 dollars, and when applied to a financial transaction will discount the transaction by 5 dollars. In another instance, the coupon rule 402 may include an amount modifier 410 of 10 percent, and will accordingly discount a transaction by 10 percent of its value. In other embodiments, the amount modifier 410 may include a maximum transaction limit, such as a coupon rule 402 where any purchase up to 50 dollars is free (e.g., as when using a $50 gift card).

The product identifier 408 may be a unique identifier corresponding to a product (e.g., a good or service) available for purchase. Types of product identifiers will be apparent to persons having skill in the relevant art and may include a universal product code (UPC), a serial number, a manufacturer part number (MPN), a European article number (EAN), an international standard book number (ISBN), etc. In some embodiments, if a coupon rule 402 includes a product identifier 408, the amount modifier 410 may include a number of products (e.g., corresponding to the product identifier 408) that may be purchased for free. In other embodiments, the amount modifier 410 may include a number discount for a financial transaction only if the product corresponding to the product identifier 408 is purchased. In another embodiment, the coupon rule 402 may include multiple amount modifiers 410 such that an indicated number of products corresponding to the product identifier 408 may be purchased for an indicated price.

Other suitable uses and implementations of the amount modifier 410, the product identifier 408, multiple amount modifiers 410, multiple product identifiers 408, or any combination thereof, will be apparent to persons having skill in the art. For example, amount modifiers 410 and product identifiers 408 may be used to implement a coupon rule 402 for stacking discounts (e.g., buy 2 and receive 5% off, buy 3 and receive 10% off, buy 4 or more and receive 20% off, etc.), or for a buy one, get one free deal. It will be apparent to persons having skill in the relevant art that the embodiments as provided herein are for illustration purposes only.

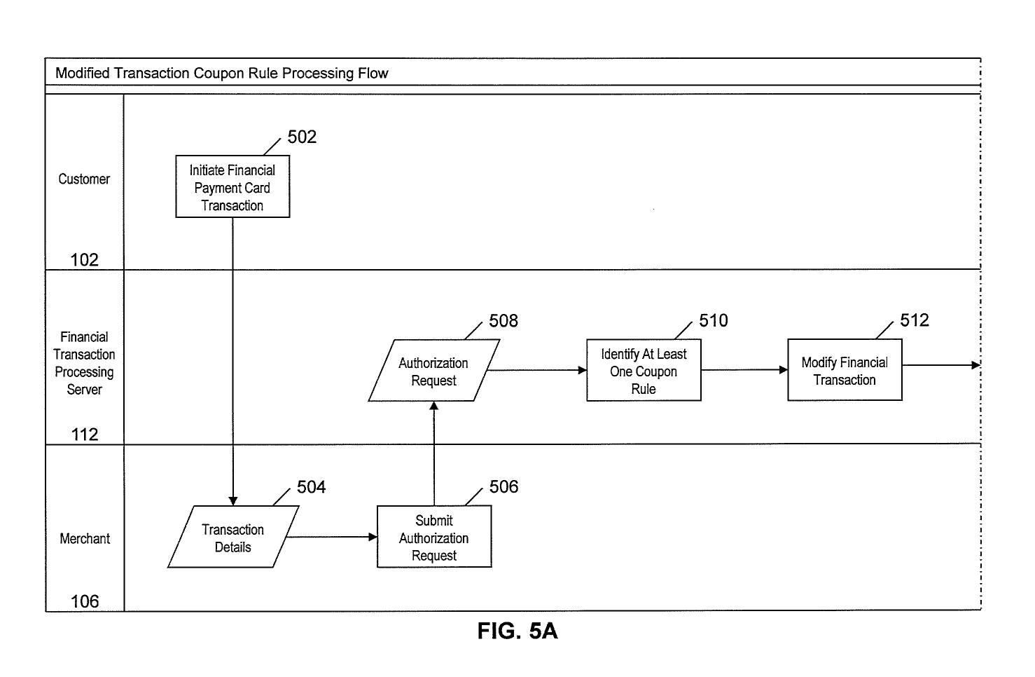

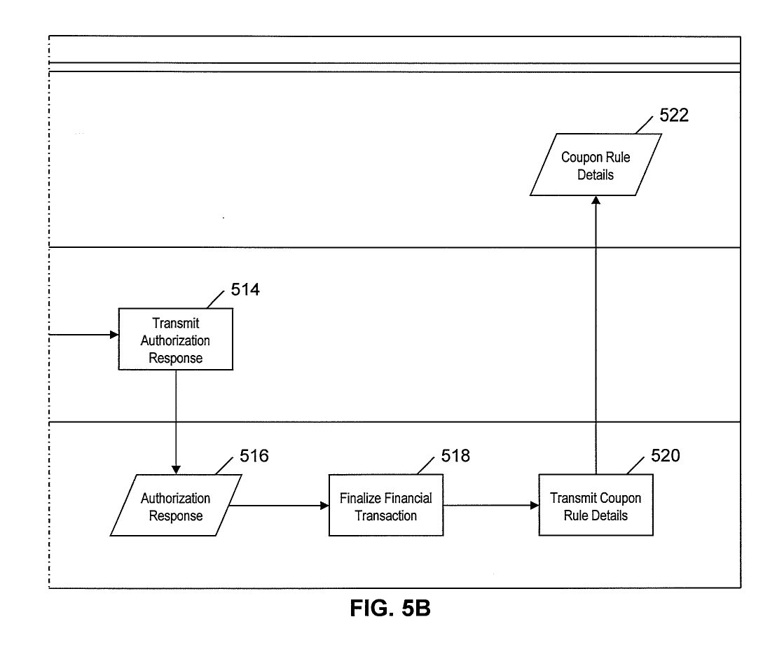

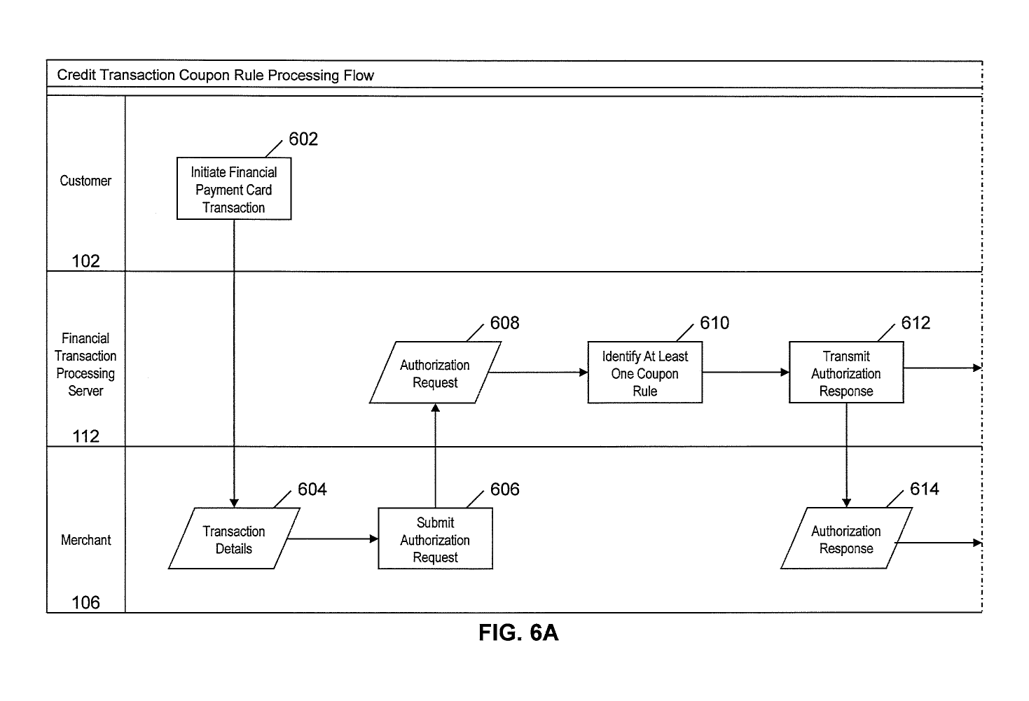

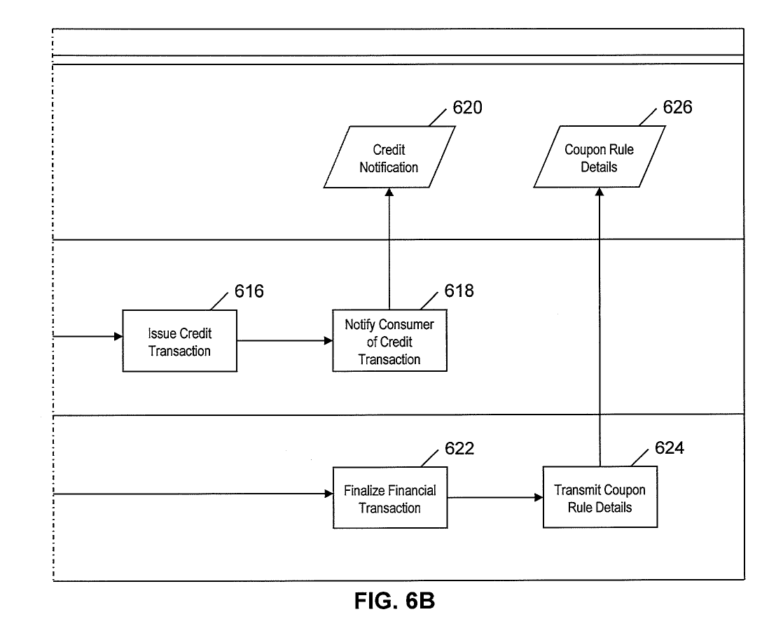

The coupon rule 402 may also include a funding account 412 associated with the coupon rule 402. In some embodiments, the funding account 412 may be a financial account associated with the consumer (e.g., corresponding to the consumer identifier 404), a financial account associated with the merchant (e.g., corresponding to the merchant identifier 406), an account associated with the acquirer 106, with the issuer 108, or any other suitable entity. The funding account 412 may be used for charging a second financial transaction, as illustrated in FIGS. 5A and 5B, below, or for crediting an account during and/or subsequent to a financial transaction, as illustrated in FIGS. 6A and 6B, below.

In some embodiments, each coupon rule 402 may also include a quantity associated with the coupon. For example, a coupon rule 402 may be used by the customer 102 multiple times, with its quantity deducted each use. In some instances, if a coupon rule 402 has run out (e.g., quantity has reached 0), the coupon rule 402 may remain in the coupon rule database 116, such that the quantity may be increased at a later date (e.g., such as by purchasing or qualifying for additional uses of the coupon, recharging of a gift card, etc.).

### Modified Transaction Coupon Rule Processing Flow

FIGS. 5A and 5B illustrate a method for modifying a financial transaction based on at least one coupon rule in accordance with exemplary embodiments. In step 502, the customer 102 may initiate a financial payment card transaction (e.g., using the payment card 120) with the merchant 106. In some embodiments, the customer 102 may initiate the transaction at a physical location of the merchant 106 (e.g., at the merchant POS 118). In other embodiments, the customer 102 may initiate the transaction from a remote location (e.g., using the network 122).

In step 504, the merchant 104 may identify transaction details associated with the financial transaction. The merchant 104 may, in step 506, submit an authorization request to the financial transaction processing server 112. The authorization request may include at least a consumer identifier (e.g., the consumer identifier 404), a merchant identifier (e.g., the merchant identifier 406), and a transaction amount. In one embodiment, the authorization request may further include at least one product identifier (e.g., the product identifier 408). In step 508, the financial transaction processing server 112 may receive the authorization request details. In step 510, the financial transaction processing server 112 may identify at least one coupon rule 402 in the coupon rule database 116 based on the information included authorization request. For example, the financial transaction processing server 112 may identify at least one coupon rule 402 where the associated consumer identifier 404 corresponds to the consumer identifier included in the authorization request and where the associated merchant identifier 406 corresponds to the merchant identifier included in the authorization request. In some embodiments, if a coupon rule 402 in the coupon rule database 116 includes additional requirements (e.g., for specific products, transaction amounts, etc.), the financial transaction processing server 112 may identify (e.g., or request from the merchant 104) additional details included in the authorization request to further identify if the coupon rule 402 may be applied to the financial transaction.

In step 512, the financial transaction processing server 112 may modify the financial transaction based on the at least one coupon rule 402. Modifying the financial transaction may include at least modifying the transaction amount based on the amount modifier (e.g., the amount modifier 410). For example, the financial transaction may be discounted by the amount modifier 410 (e.g., $5 off, 10% off, etc.). Other methods for modifying the transaction (e.g., based on different coupon rule implementations) will be apparent to persons having skill in the relevant art. In step 514, the financial transaction processing server 112 may process the financial transaction (e.g., for the modified transaction amount) and may transmit a response to the authorization request to the merchant 104. In one embodiment, the response to the authorization request may be formatted in the ISO 8583 standard.

In step 516, the merchant 104 may receive the authorization response and, in step 518, may finalize the financial transaction accordingly. For example, if the transaction was denied, the merchant 104 may notify the customer 102 and may request alternative payment and/or cancel the transaction. If the transaction was approved, the merchant 104 may accept the payment for the transaction and may deliver the product to the customer 102.

In step 520, the merchant 104 may transmit coupon rule details to the customer 102. In some embodiments, transmitting the coupon rule details may be performed by the financial transaction processing server 112. In step 522, the customer 102 may receive the coupon rule details, which may be displayed to and/or viewed by the customer 102. The coupon rule details may include a summary of the coupon rules applied to the financial transaction, such as which coupons were applied, respective requirements and resulting discounts for each one, quantity of the respective coupon remaining, value of the respective coupon remaining, new coupons obtained from the purchase, etc.

### Credit Transaction Coupon Rule Processing Flow

FIGS. 6A and 6B illustrate a method for processing a financial transaction and issuing a subsequent credit based on at least one coupon rule in accordance with exemplary embodiments.

In step 602, the customer 102 may initiate a financial payment card transaction (e.g., using the payment card 120) with the merchant 106. In some embodiments, the customer 102 may initiate the transaction at a physical location of the merchant 106 (e.g., at the merchant POS 118). In other embodiments, the customer 102 may initiate the transaction from a remote location (e.g., using the network 122).

In step 604, the merchant 104 may identify transaction details associated with the financial transaction. The merchant 104 may, in step 606, submit an authorization request to the financial transaction processing server 112. The authorization request may include at least a consumer identifier (e.g., the consumer identifier 404), a merchant identifier (e.g., the merchant identifier 406), and a transaction amount. In one embodiment, the authorization request may further include at least one product identifier (e.g., the product identifier 408).

In step 608, the financial transaction processing server 112 may receive the authorization request details. In step 610, the financial transaction processing server 112 may identify at least one coupon rule 402 in the coupon rule database 116 based on the information included authorization request. For example, the financial transaction processing server 112 may identify at least one coupon rule 402 where the associated consumer identifier 404 corresponds to the consumer identifier included in the authorization request and where the associated merchant identifier 406 corresponds to the merchant identifier included in the authorization request. In some embodiments, if a coupon rule 402 in the coupon rule database 116 includes additional requirements (e.g., for specific products, transaction amounts, etc.), the financial transaction processing server 112 may identify (e.g., or request from the merchant 104) additional details included in the authorization request to further identify if the coupon rule 402 may be applied to the financial transaction.

In step 612, the financial transaction processing server 112 may transmit a response to the authorization request to the merchant 104. In one embodiment, the response to the authorization request may be formatted in the ISO 8583 standard. In step 614, the merchant 104 may receive the authorization response and, in step 622, may finalize the transaction accordingly. For example, if the transaction was denied, the merchant 104 may notify the customer 102 and may request alternative payment and/or cancel the transaction. If the transaction was approved, the merchant 104 may accept the payment for the transaction and may deliver the product to the customer 102.

In step 616, the financial transaction processing server 112 may issue a credit transaction based on the at least one coupon rule 402 where the amount of the credit is based on the amount modifier (e.g., the amount modifier 410). The credit transaction may be a credit that is applied to a financial account associated with the customer 102 (e.g., and stored in the account database 114), a refund that is issued on the payment card 120, or other types of transactions that will be apparent to persons having skill in the relevant art and are suitable for performing the functions as disclosed herein.

In step 618, the financial transaction processing server 112 may notify the customer 102 of the credit, which may be received by the customer 102 in step 620. Methods of notifying the customer 102 will be apparent to persons having skill in the relevant art and may include e-mail, short message service (SMS) message, telephone call, push notification on a mobile device, a combination thereof, etc. In one embodiment, the customer 102 may elect a preferred method of notification.

In step 624, the merchant 104 may transmit coupon rule details to the customer 102. In some embodiments, transmitting the coupon rule details may be performed by the financial transaction processing server 112. In step 626, the customer 102 may receive the coupon rule details, which may be displayed to and/or viewed by the customer 102. The coupon rule details may include a summary of the coupon rules applied to the financial transaction, such as which coupons were applied, respective requirements and resulting discounts for each one, quantity of the respective coupon remaining, value of the respective coupon remaining, new coupons obtained from the purchase, etc.

### Server Architecture

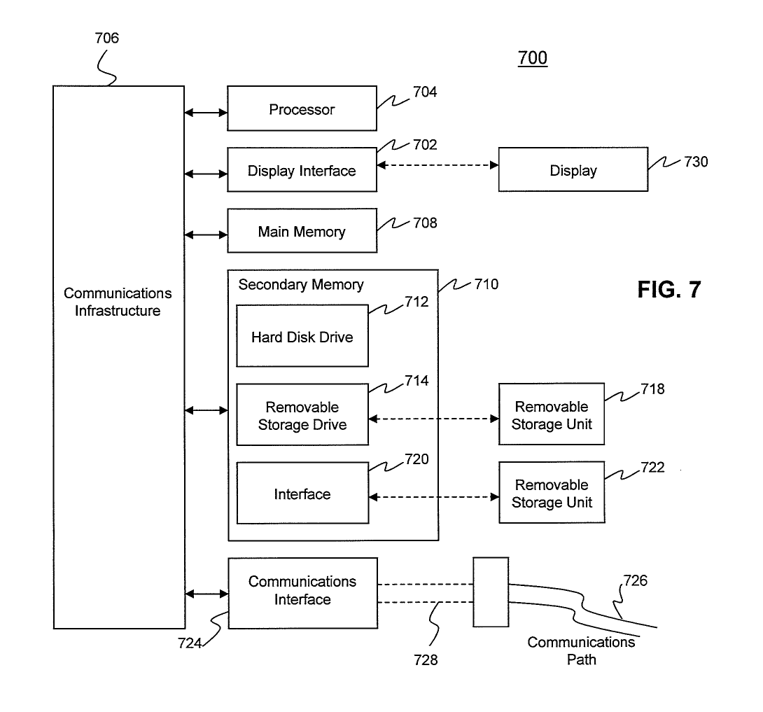

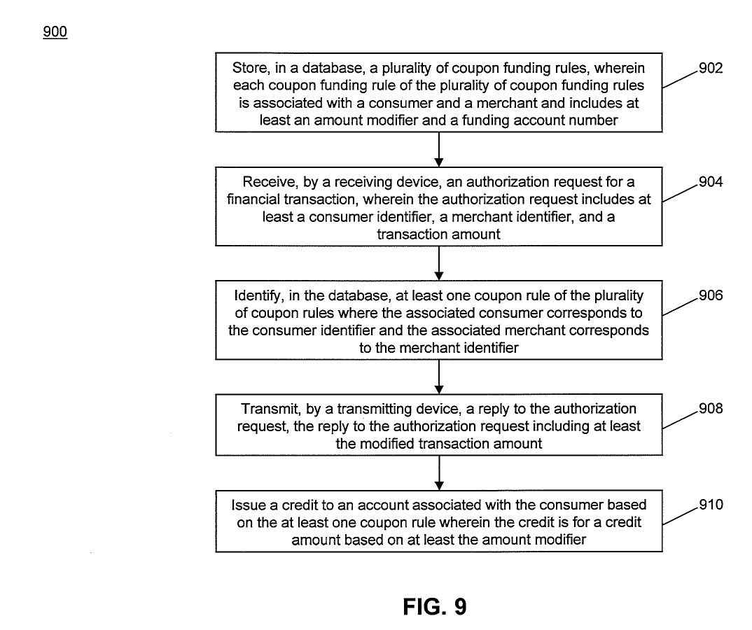

FIG. 7 illustrates a computer system 700 in which embodiments of the present disclosure, or portions thereof, may be implemented as computer-readable code. For example, the financial transaction processing server 112, merchant POS 118, or portions of the acquirer 106 or issuer 108, of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5A, 5B, 6A, 6B, and 8-9.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network (e.g., the network 122), multi-core message-passing scheme, etc. The computer system 800 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g. DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 5A, 5B, 6A, 6B, and 8-9, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

### First Exemplary Method For Applying Coupon Rules to a Financial Transaction

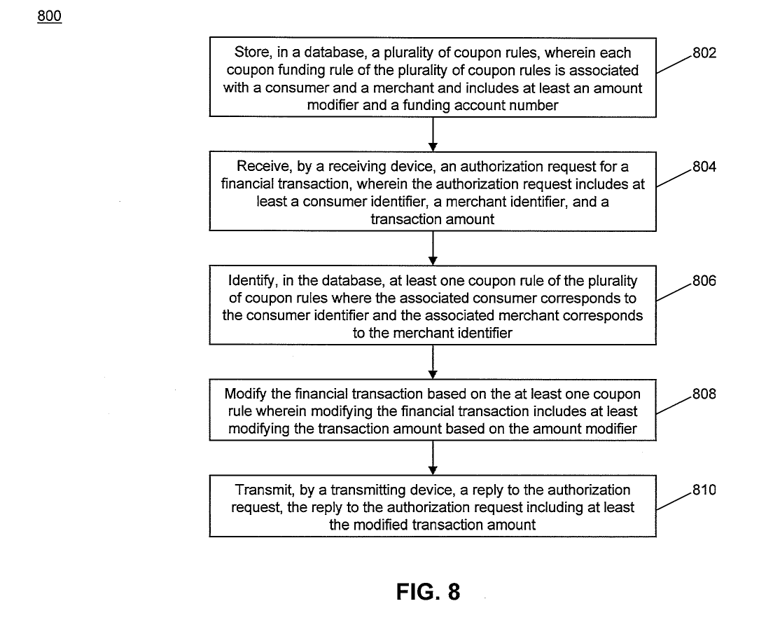

FIG. 8 illustrates a method 800 for applying coupon rules to a financial transaction.

In step 802, a plurality of coupon rules (e.g., coupon rule 402) may be stored in a database (e.g., the coupon rule database 116), wherein each coupon rule 402 of the plurality of coupon rules is associated with a consumer (e.g., the customer 102) and a merchant (e.g., the merchant 104) and includes at least an amount modifier (e.g., the amount modifier 410) and a funding account number (e.g., the funding account 412). In one embodiment, each coupon rule 402 may further include at least one product identifier (e.g., the product identifier 408). In a further embodiment, the at least one product identifier 408 may be at least one of: a universal product code, a manufacturer part number, European article number, serial number, and international standard book number.

In one embodiment, the amount modifier 410 may be a number or a percentage. In an embodiment, the funding account 412 may correspond to a financial account associated with the customer 102. In an alternative embodiment, the funding account 412 may correspond to a financial account associated with the merchant 104.

In step 804, an authorization request for a financial transaction may be received by a receiving device (e.g., the receiving unit 302), wherein the authorization request includes at least a customer identifier (e.g., the customer identifier 404), a merchant identifier (e.g., the merchant identifier 406), and a transaction amount. In one embodiment, the authorization request is formatted under the International Organization for Standardization ISO 8583 standard.

In step 806, at least one coupon rule 402 of the plurality of coupon rules may be identified where the associated consumer corresponds to the customer identifier 404 and the associated merchant corresponds to the merchant identifier 406. In embodiments where each coupon rule 402 may include at least one product identifier 408, identifying at least one coupon rule 402 may include identifying where the at least one product identifier 408 corresponds to at least one product identification number that may be included in the received authorization request.

In step 808, the financial transaction may be modified based on the at least one coupon rule 402 wherein modifying the financial transaction includes at least modifying the transaction amount based on the amount modifier 410. In one embodiment, modifying the financial transaction may further include splitting the financial transaction into a first financial transaction for a first charge amount and a second financial transaction for a second charge amount, wherein one of the first and second charge amounts is the modified transaction amount.

In step 810, a reply to the authorization request may be transmitted by a transmitting device (e.g., the transmitting unit 306), the reply to the authorization request including at least the modified transaction amount.

### Second Exemplary Method For Applying Coupon Rules to a Financial Transaction

FIG. 8 illustrates a method 900 for applying coupon rules to a financial transaction.

In step 902, a plurality of coupon rules (e.g., coupon rule 402) may be stored in a database (e.g., the coupon rule database 116), wherein each coupon rule 402 of the plurality of coupon rules is associated with a consumer (e.g., the customer 102) and a merchant (e.g., the merchant 104) and includes at least an amount modifier (e.g., the amount modifier 410) and a funding account number (e.g., the funding account 412). In one embodiment, each coupon rule 402 may further include at least one product identifier (e.g., the product identifier 408). In a further embodiment, the at least one product identifier 408 may be at least one of: a universal product code, a manufacturer part number, European article number, serial number, and international standard book number.

In one embodiment, the amount modifier 410 may be a number or a percentage. In an embodiment, the funding account 412 may correspond to a financial account associated with the customer 102. In an alternative embodiment, the funding account 412 may correspond to a financial account associated with the merchant 104.

In step 904, an authorization request for a financial transaction may be received by a receiving device (e.g., the receiving unit 302), wherein the authorization request includes at least a customer identifier (e.g., the customer identifier 404), a merchant identifier (e.g., the merchant identifier 406), and a transaction amount. In one embodiment, the authorization request is formatted under the International Organization for Standardization ISO 8583 standard. In some embodiments, the authorization request may include at least one product identification number (e.g., corresponding to products for purchase in the financial transaction).

In step 906, at least one coupon rule 402 of the plurality of coupon rules may be identified where the associated consumer corresponds to the customer identifier 404 and the associated merchant corresponds to the merchant identifier 406. In embodiments where each coupon rule 402 may include at least one product identifier 408, identifying at least one coupon rule 402 may include identifying where the at least one product identifier 408 corresponds to at least one product identification number that may be included in the received authorization request.

In step 908, a reply to the authorization request may be transmitted by a transmitting device (e.g., the transmitting unit 306), the reply to the authorization request including at least the modified transaction amount. In one embodiment, the reply to the authorization request may be formatted pursuant to the ISO 8583 standard. In step 910, a credit may be issued to an account associated with the customer 102 based on the at least one coupon rule 402, wherein the credit is for a credit amount based on at least the amount modifier 410.

Techniques consistent with the present disclosure provide, among other features, systems and methods for applying coupon rules to a financial transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for applying coupon rules to a financial transaction, comprising:
storing, in a database, a plurality of coupon rules, wherein each coupon rule of the plurality of coupon rules is associated with a consumer and a merchant and includes at least an amount modifier and a funding account number;
receiving, by a receiving device, an authorization request for a financial transaction, wherein the authorization request includes at least a consumer identifier, a merchant identifier, and a transaction amount;
identifying, in the database, at least one coupon rule of the plurality of coupon rules where the associated consumer corresponds to the consumer identifier and the associated merchant corresponds to the merchant identifier;
modifying the financial transaction based on the at least one coupon rule wherein modifying the financial transaction includes at least modifying the transaction amount based on the amount modifier; and
transmitting, by a transmitting device, a reply to the authorization request, the reply to the authorization request including at least the modified transaction amount.

2. The method of claim 1, wherein the step of modifying the financial transaction further comprises splitting the financial transaction into a first financial transaction including a first charge amount and a second financial transaction including a second charge amount, wherein one of the first charge amount and second charge amount is the modified transaction amount.

3. The method of claim 1, wherein each coupon rule of the plurality of funding rules further includes a product identification number,
the authorization request further includes at least one product identifier, and
the identifying step further includes identifying the at least one coupon rule of the plurality of coupon rules where the included product identification number corresponds to the at least one product identifier.

4. The method of claim 3, wherein the product identification number is at least one of a universal product code, manufacturer part number, or European article number.

5. The method of claim 1, wherein the amount modifier is a number or a percentage.

6. The method of claim 1, wherein the authorization request is formatted under the International Organization for Standardization ISO 8583 standard.

7. The method of claim 1, wherein the funding account number corresponds to a financial account associated with the merchant.

8. The method of claim 1, wherein the funding account number corresponds to the financial account associated with the consumer.

9. A method for applying coupon rules to a financial transaction, comprising:
storing, in a database, a plurality of coupon rules, wherein each coupon rule of the plurality of coupon rules is associated with a consumer and a merchant and includes at least an amount modifier and a funding account number;
receiving, by a receiving device, an authorization request for a financial transaction, wherein the authorization request includes at least a consumer identifier, a merchant identifier, and a transaction amount;
identifying, in the database, at least one coupon rule of the plurality of coupon rules where the associated consumer corresponds to the consumer identifier and the associated merchant corresponds to the merchant identifier;
transmitting, by a transmitting device, a reply to the authorization request, the reply to the authorization request including at least the modified transaction amount; and
issuing a credit to an account associated with the associated consumer based on the at least one coupon rule wherein the credit is for a credit amount based at least on the amount modifier.

10. A system for applying coupon rules to a financial transaction, comprising:
a database configured to store a plurality coupon rules, wherein each coupon rule of the plurality of coupon rules is associated with a consumer and a merchant and includes at least an amount modifier and a funding account number;
a receiving device configured to receive an authorization request for a financial transaction, wherein the authorization request includes at least a consumer identifier, a merchant identifier, and a transaction amount;
a processing device configured to
identify, in the database, at least one coupon rule of the plurality of coupon rules where the associated consumer corresponds to the consumer identifier and the associated merchant corresponds to the merchant identifier, and
modify the financial transaction based on the at least one coupon rule wherein modifying the financial transaction includes at least modifying the transaction amount based on the amount modifier; and
a transmitting device configured to transmit a reply to the authorization request, the reply to the authorization request including at least the modified transaction amount.

11. The system of claim 10, wherein the step of modifying the financial transaction further comprises splitting the financial transaction into a first financial transaction including a first charge amount and a second financial transaction including a second charge amount, wherein one of the first charge amount and second charge amount is the modified transaction amount.

12. The system of claim 10, wherein each coupon rule of the plurality of coupon rules further includes a product identification number,
the authorization request further includes at least one product identifier, and
identifying the at least one coupon rule of the plurality of coupon rules further includes the included product identification number corresponding to the at least one product identifier.

13. The system of claim 10, wherein the product identification number is at least one of a universal product code, manufacturer part number, or European article number.

14. The system of claim 10, wherein the amount modifier is a number or a percentage.

15. The system of claim 10, wherein the authorization request is formatted under the International Organization for Standardization ISO 8583 standard.

16. The system of claim 10, wherein the funding account number corresponds to a financial account associated with the merchant.

17. The system of claim 10, wherein the funding account number corresponds to the financial account associated with the consumer.

18. A system for applying coupon rules to a financial transaction, comprising:
a database configured to store a plurality coupon rules, wherein each coupon rule of the plurality of coupon rules is associated with a consumer and a merchant and includes at least an amount modifier and a funding account number;
a receiving device configured to receive an authorization request for a financial transaction, wherein the authorization request includes at least a consumer identifier, a merchant identifier, and a transaction amount;
a processing device configured to
identify, in the database, at least one coupon rule of the plurality of coupon rules where the associated consumer corresponds to the consumer identifier and the associated merchant corresponds to the merchant identifier, and
issue a credit to an account associated with the associated consumer based on the at least one coupon rule wherein the credit is for a credit amount based on at least the amount modifier; and
a transmitting device configured to transmit a reply to the authorization request, the reply to the authorization request including at least the modified transaction amount.
